(19) United States
(12) Patent Application Publication
(10) Pub. No.: US 2003/0075158 A1
(43) Pub. Date: Apr. 24, 2003

(54) Method and device for a mass flow determination via a control valve and for determining a modeled induction pipe pressure

(76) Inventors: Leonhard Milos, Stuttgart (DE); Ernst Wild, Oberriexingen (DE); Jochen Gross, St. Wendel (DE); Oliver Schlesiger, Asperg (DE); Kristina Eberle, Markgroningen (DE); Roland Herynek, Oetisheim (DE); Patrick Janin, Stuttgart (DE); Manfred Pfitz, Vaihingen (DE)

Correspondence Address: KENYON & KENYON, ONE BROADWAY, NEW YORK, NY, 10004, US

(21) Appl. No.: 10/203,593

(22) PCT Filed: Jan. 18, 2001
(86) PCT No.: PCT/DE01/00200

(30) Foreign Application Priority Data
Feb. 9, 2000 (DE) 100 05 569.5
Aug. 22, 2000 (DE) 100 41 073.1

(51) Int. Cl. F02M 25/07; G01M 19/00

(52) U.S. Cl. 123/568.21; 73/118.1

(57) ABSTRACT

A valve flow characteristic line is adapted by weighting the valve position as an input variable using a variable offset value. To calculate a robust model of the intake manifold pressure, a modeled partial pressure of the recirculated exhaust gas is determined so that it differs as little as possible from the actual partial pressure of the recirculated exhaust gas. To do so, a modeled partial pressure of the recirculated exhaust gas is derived from a flow characteristic of a valve in an exhaust gas recirculating line as a function of the valve position. The modeled partial pressure of the recirculated exhaust gas derived from the flow characteristic is corrected adaptively as a function of the difference between the modeled intake manifold pressure and a measured intake manifold pressure.

### FIELD OF THE INVENTION

The present invention relates to a method and a device for determining a mass flow rate through a control valve and for determining a modeled intake manifold pressure in an internal combustion engine having exhaust gas recirculation in which the partial pressure of the fresh gas and the recirculated exhaust gas is combined.

### BACKGROUND INFORMATION

In applications in the field of automotive control, it may be important to know the mass flow rate through a control valve. One example application is the determination of partial pressure, for which it is important to know the precise mass flow rate through an exhaust gas recirculating control valve. In control valves, the relationship between valve position and mass flow rate changes over time due to various factors such as aging, soiling, etc., so there is a demand for adjustment of this relationship to improve upon the accuracy of the mass flow rate determination, in the case of valve soiling in particular.

German Patent Application No. 197 56 919 describes that the intake manifold pressure may be calculated from the sum of the fresh gas partial pressure and the partial pressure of the recirculated exhaust gas.

In internal combustion engines having direct gasoline injection, an external exhaust gas recirculation is required for compliance with the limit values required by law for NOx emissions in exhaust gas. Elevated crude NOx emissions in exhaust gas occur mainly in stratified charge engine operation with an air/fuel ratio of λ>1. Due to the exhaust gas recirculation, in which an exhaust gas mass flow is removed from the exhaust gas system and sent back to the engine via an exhaust gas recirculating valve, the peak temperature of the combustion process is lowered and thus crude NOx emissions are reduced.

It is generally not possible to measure the partial pressure of the recirculated exhaust gas in the exhaust gas recirculating line, but an estimate of the recirculated exhaust gas may be determined. To implement a robust and accurate intake manifold pressure model that is related to the partial pressure of the recirculated exhaust gas, it is important to create an accurate model for the partial pressure of the recirculated exhaust gas.

### SUMMARY

According to an embodiment of the present invention, the mass flow rate through a valve is determined according to a valve flow characteristic as a function of the valve position, and is adapted to improve accuracy by using an offset value based on the valve position. This offset value is constant over the valve position at different degrees of soiling of the valve. In the case of an offset value based on mass flow, however, a reduction in the offset value is observed with a smaller valve opening for a certain degree of soiling.

The present invention may be advantageously applied to a control valve for exhaust gas recirculation and can also be advantageously applied to other control valves where the flow rate is determined on the basis of a characteristic curve as a function of the valve position (e.g., throttle valves, etc.).

A modeled partial pressure of the recirculated exhaust gas may be derived from a flow characteristic of a valve in an exhaust gas recirculating line as a function of the valve position, and the partial pressure of the recirculated exhaust gas modeled and derived from the flow characteristic may be corrected in an adaptive manner as a function of the difference between the modeled intake manifold pressure and a measured intake manifold pressure.

The mass flow rate through the exhaust gas recirculating valve may be determined as a function of the flow characteristic of the exhaust gas recirculating valve. In addition, a relative charge in the intake manifold may calculated from the mass flow rate by dividing this by the engine speed, and then the partial pressure of the recirculated exhaust gas may be derived from the relative charge in the intake manifold.

A relative fresh air charge in the intake manifold may be determined from the mass flow rate of air through the throttle valve in the intake manifold by dividing the mass flow rate of air by the engine speed and then the partial pressure of the fresh gas may be derived from the relative fresh air charge.

### BRIEF DESCRIPTION OF THE DRAWINGS

FIG. 1 shows a schematic diagram of an internal combustion engine having exhaust gas recirculation according to an embodiment of the present invention.

FIG. 2 shows a function chart for calculating a modeled intake manifold pressure according to an embodiment of the present invention.

FIG. 3 shows an expanded portion of the function chart in FIG. 2 for adaptive adjustment of the flow characteristic of the exhaust gas recirculating valve according to an embodiment of the present invention.

FIG. 4 shows a flow chart for the offset correction of the flow characteristic having an offset value based on the valve position according to an embodiment of the present invention.

### DETAILED DESCRIPTION

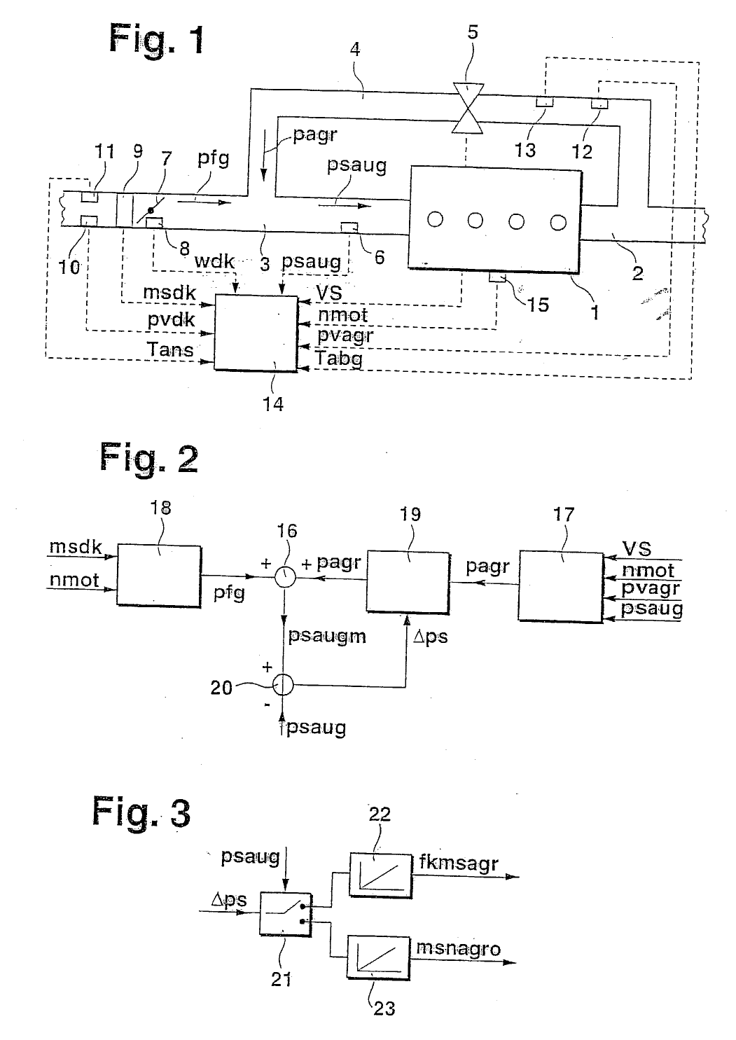

FIG. 1 shows schematically an internal combustion engine 1 having an exhaust gas channel 2 and an intake manifold 3. An exhaust gas recirculating line 4 branches off from exhaust gas channel 2 and opens into intake manifold 3. A valve 5 is provided in exhaust gas recirculating line 4. The recirculated exhaust gas mass, i.e., partial pressure pagr of the recirculated gas, is controllable via this exhaust gas recirculating valve 5. Downstream from the junction of exhaust gas recirculating line 4, a pressure sensor 6 is situated in intake manifold 3 to measure intake manifold pressure psaug. Upstream from the junction of exhaust gas recirculating line 4, there is a throttle valve 7 that includes a potentiometer 8 which detects throttle valve position wdk. Upstream from throttle valve 7, an air mass sensor 9 is situated in intake manifold 3, that measures mass flow rate of air msdk through throttle valve 7. In addition, a pressure sensor 10 which measures pressure pvdk in the intake manifold upstream from the throttle valve is provided, and a temperature sensor 11 which measures intake air temperature TANS is also provided. A pressure sensor 12 which measures exhaust gas pressure pvagr upstream from exhaust gas recirculating valve 5 and a temperature sensor 13 which detects temperature Tabg of the exhaust gas upstream from exhaust gas recirculating valve 5 are situated in exhaust gas recirculating line 4 upstream from the exhaust gas recirculating valve.

A control device 14 receives all the sensed variables mentioned above. These include measured intake manifold pressure psaug, throttle valve position wdk, mass flow rate of air msdk upstream from the throttle, pressure pvdk upstream from the throttle valve, intake air temperature Tans, position vs of exhaust gas recirculating valve 5, engine rotational speed nmot detected by a sensor 15, exhaust gas pressure pvagr upstream from the exhaust gas recirculating valve and temperature Tabg of the exhaust gas upstream from the exhaust gas recirculating valve. Variables pvdk, Tabg and pvagr may also be determined from other operating variables of the engine by using model calculations. Control device 14 determines partial pressure pfg of the fresh gas and partial pressure pagr of the recirculated exhaust gas from these input variables.

As shown by the function chart in FIG. 2, the desired modeled intake manifold pressure psaugm is formed by an additive linkage 16 of partial pressure pfg of the fresh gas and modeled partial pressure pagr of the recirculated exhaust gas. A description is given below of how control device 14 derives partial pressure pfg of the fresh gas and partial pressure pagr of the recirculated gas.

To determine partial pressure pagr of the recirculated exhaust gas, mass flow msagr through the exhaust gas recirculating valve is first calculated according to equation (1).

msagr=fkmsagr·[msnagr (vs)+msnagro]·pvagr/1013hPa·\sqrt{273/Tagr}·KLAF (psaug/pvagr) (1)

In equation (1), msnagr(vs) denotes the standard mass flow through the exhaust gas recirculating valve at an exhaust gas pressure pvagr upstream from the exhaust gas recirculating valve of 1013 hPa, Tagr=213 K and psaug/pvagr<0.52. This standard mass flow msnagr corresponds to the flow characteristic of exhaust gas recirculating valve 5, which is usually made available by the valve manufacturer and is stored in function block 17 (see FIG. 2). This standard mass flow msnagr(vs) is thus a variable derived from the flow characteristic as a function of valve position vs. The flow characteristic takes into account only the function of exhaust gas recirculating valve 5, but not changes in flow due to manufacturing tolerances and aging, nor does it take into account the flow properties of exhaust gas recirculating line 4. For this reason, correction terms fkmsagr and msnagro, which may be varied adaptively, are provided in equation (1) for mass flow msagr through the exhaust gas recirculating valve. Correction term msnagro takes into account an offset of the flow characteristic. KLAF is a value taken from a characteristic curve describing the velocity of flow through the exhaust gas recirculating valve in relation to the velocity of sound as a function of the pressure ratio between pressure psaug downstream from the exhaust gas recirculating valve and pressure pvagr upstream from the exhaust gas recirculating valve. The velocity of flow reaches the velocity of sound at psaug/pvagr<0.52 and it drops below the velocity of sound at psaug/pvagr>0.52.

After calculating mass flow msagr through the exnaust gas recirculating valve according to equation (1), in function block 17 it is converted to a relative charge rfagr in the intake manifold due to the recirculated exhaust gas.

rfagr=msagr/(nmot·K) (2)

Constant K is a function of the cylinder displacement volume and the standard density of air.

Finally, partial pressure pagr is calculated according to equation (3) from relative charge rfagr derived from the recirculated exhaust gas in the intake manifold due to the recirculated exhaust gas.

pagr=rfagr/(KFURL·ftsr) (3)

Characteristics map variable KFURL indicates the ratio of the effective cylinder displacement volume to the cylinder displacement volume. Variable ftsr indicates the temperature ratio of 273K to the gas temperature in the combustion chamber.

To determine partial pressure pfg of the fresh gas in the intake manifold, first a relative fresh air charge rlfg in the intake manifold is determined according to equation

rlfg=msdk/(nmot·K) (4)

The relative fresh air charge rlfg in the intake manifold is calculated from the mass flow rate of air msdk upstream from the throttle valve by dividing it by the engine speed nmot and constant K (see equation (2)).

After calculating relative fresh air charge rlfg, partial pressure pfg of the fresh gas is derived from it according to equation (5) in function block 18

pfg=rlfg/(KFURL·ftsr) (5)

Partial pressure pfg of the fresh gas is thus formed by dividing relative fresh air charge rlfg by variables KFURL and ftsr already explained above with respect to equation (3).

Mass flow rate of air msdk upstream from the throttle valve may either be measured with sensor 9 or derived from other operating variables according to equation (6).

msdk=msndk(wdk)·pvdk/1013 hPa\sqrt{273/Tans}·KLAF(psaug/pvdk) (6)

Where msndk(wdk) denotes the standard mass flow through the throttle valve at a pressure pvdk upstream from the throttle valve of 1013 hPa, an intake air temperature Tans=273K and a pressure ratio upstream and downstream from the throttle valve (psaug/pvdk<0.52). Value KLAF is obtained from a characteristic curve and supplies the velocity of flow through the throttle valve in relation to the velocity of sound as a function of the pressure ratio psaug/pvdk at the throttle valve. At psaug/pvdk<0.52 the velocity of sound is established and at psaug/pvdk>0.52 the velocity of flow drops below the velocity of sound.

As explained above, partial pressure pagr of the recirculated exhaust gas derived from the flow characteristic in function block 17 is subject to error because this flow characteristic of exhaust gas recirculating valve 5 fails to take into account manufacturing tolerances, changes in flow due to aging or the flow properties of exhaust gas recirculating line 4. To reduce the error in partial pressure pagr of the recirculated gas, a function block 19 is provided wherein partial pressure pagr of the recirculated gas is corrected. The goal here is for the modeled partial pressure pagr of the recirculated exhaust gas after correction to correspond as accurately as possible to the actual partial pressure in the exhaust gas recirculating line, so that the modeled intake manifold pressure psaugm derived from the sum of partial pressure pfg of the fresh gas and partial pressure pagr of the recirculated gas is also as accurate as possible. For error correction of partial pressure pagr of the recirculated exhaust gas, a correction variable Δps is formed by forming a difference 20 from modeled intake manifold pressure psaugm and intake manifold pressure psaug measured by pressure sensor 6. This correction variable is sent to a function block 19.

As shown in FIG. 3, correction variable Δps is sent via switch 21 either to integrator 22 or integrator 23. Integrator 22 supplies correction term fkmsagr occurring in equation (1) and integrator 23 supplies offset correction term msnagro. Integrators 22 and 23 cause correction terms fkmsagr and msnagro to increase to the extent indicated by correction variable Δps. Thus, in function block 20, partial pressure pagr of the recirculated exhaust gas is altered adaptively via correction terms fkmsagr and msnagro until the deviation between measured intake manifold pressure psaug and modeled intake manifold pressure psaugm is minimal. A threshold decision which ascertains whether measured intake manifold pressure psaug exceeds the threshold of 400 hPa is made in switching block 21. At a measured intake manifold pressure psaug, which is above the threshold of 400 hPa, integrator 23 is controlled by correction variable Δps. If measured intake manifold psaug is below the threshold of 400 hPa, correction variable Δp is switched to integrator 22 for the correction term fkmsagr.

To determine the partial pressure, the mass flow rate through the valve is needed. It is determined on the basis of an adaptable characteristic curve depending on the valve position. Such a characteristic curve may also be essential in conjunction with other applications, so that the characteristic curve adaptation described here may be in other application. For example, the mass flow rate of air through a throttle valve is also determined according to a flow characteristic, which may also change due to soiling of the valve. The offset value is formed, as illustrated in FIG. 3, from the deviation of a value calculated using the characteristic curve from a measured value, e.g., by integration.

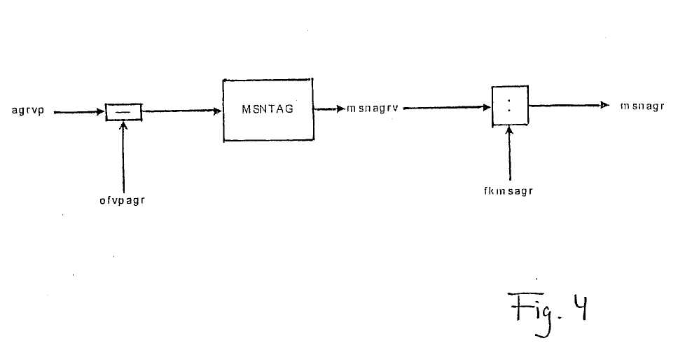

FIG. 4 shows a flow chart for adaptation of such a flow characteristic. The input variable is valve position (vs) with which offset value (off) (for example, of an AGR valve ofvpagr, see FIG. 3, offset value msnagro, for example) is combined in gate 25. The result is used to address flow characteristic MSNTAG 26 whose output variable is the standard mass flow msnv (for example, of an AGR valve msnagr) through the control valve, which is optionally combined with a slope adaptation factor for standard mass flow msn (for example, of an AGR valve msnagr) by gate 27 (division).

In the above embodiment of a partial pressure determination with the help of the flow characteristic through an AGR valve, the offset value is based on the mass flow as described in equation (1). It may be more advantageous to base it here again on the valve position. This then yields the following calculation equation for the mass flow:

msagr=1/fkmsagr·[msnagr]·pvagr/1013 hpa·\sqrt{273/Tagr}·KLAF(psaug/pvagr) (7)

This equation represents the physical behavior of the mass flow through the AGR valve as a function of the soiling of the valve. In contrast with equation (1), the offset is no longer apparent. It is analyzed in addressing the flow characteristic whose output signal is variable msnagr (mass flow under standard conditions). The output value is thus not adapted, and instead the input value of the characteristic curve, i.e., the valve position, is adapted via the offset.

What is claimed is:

1. A method of determining a mass flow rate through a control valve
whose position is detected,
the mass flow being determined according to a characteristic curve, as a function of the position,
the characteristic curve being adapted using a variable offset value,
wherein the valve position is corrected using the offset value, and the mass flow is determined from the characteristic curve as a function of the corrected valve position.

2. The method according to claim 1,
wherein the offset value is derived from the deviation between a variable calculated on the basis of the mass flow and the measured variable.

3. A method of determining a modeled intake manifold pressure in an internal combustion engine having exhaust gas recirculation, the sum of the partial pressure (pfg) of the fresh gas and the partial pressure (pagr) of the recirculated exhaust gas being calculated,
wherein a modeled partial pressure (pagr) of the recirculated exhaust gas is derived from a flow characteristic of a valve (5) in an exhaust gas recirculating line (4) as a function of the valve position (vs), and the modeled partial pressure (pagr) of the recirculated exhaust gas is corrected adaptively, as a function of the difference (Δps) between the modeled intake manifold pressure (psaugm) and a measured intake manifold pressure (psaug), (20).

4. The method according to claim 3,
wherein the mass flow through the exhaust gas recirculating valve (5) is determined as a function of the flow characteristic of the exhaust gas recirculating valve (5); a relative charge in the intake manifold (3) is calculated from the mass flow by dividing it by the engine rotational speed (nmot), and the partial pressure (pagr) of the recirculated exhaust gas is derived from the relative charge in the intake manifold (3).

5. The method according to claim 3,
wherein a relative fresh air charge in the intake manifold (3) is determined from the mass flow rate of air (msdk) through the throttle valve (7) in the intake manifold (3), by dividing the mass flow rate of air (msdk) by the engine rotational speed (nmot), and the partial pressure (pfg) of the fresh gas is derived from the relative fresh air charge.

6. A device for determining a mass flow through a control valve, the device having a control unit that detects the position of the control valve, determining the mass flow according to a characteristic curve as a function of the position, and adapting the characteristic curve using a variable offset value,
wherein the control unit has means which correct the valve position using the offset value and determine the mass flow from the characteristic curve as a function of the corrected valve position.

7. A device for determining a modeled intake manifold pressure in an internal combustion engine having exhaust gas recirculation, the device calculating the sum of the partial pressure (pfg) of the fresh gas and the partial pressure (pagr) of the recirculated exhaust gas,
wherein means (17) are provided which derive a modeled partial pressure (pagr) of the recirculated exhaust gas from a flow characteristic of a valve (5) in an exhaust gas recirculating line (4) as a function of the valve position (vs), and additional means (19) are provided which adaptively correct the modeled partial pressure (pagr) of the recirculated exhaust gas derived from the flow characteristic as a function of the difference (Δps) between the modeled intake manifold pressure (psaug) and a measured intake manifold pressure (psaug).
